(19) United States
(12) Patent Application Publication
(10) Pub. No.: US 2019/0155948 A1
(43) Pub. Date: May 23, 2019

(54) RE-RANKING RESOURCES BASED ON CATEGORICAL QUALITY

(71) Applicant: Google Inc., Mountain View, CA (US)

(72) Inventors: Trystan G. Upstill, Palo Alto, CA (US); Abhishek Das, San Francisco, CA (US); Jeongwoo Ko, Irvine, CA (US); Neesha Subramaniam, Mountain View, CA (US); Vishnu P. Natchu, Mountain View, CA (US)

(21) Appl. No.: 14/674,802

(22) Filed: Mar. 31, 2015

Related U.S. Application Data
(60) Provisional application No. 61/972,821, filed on Mar. 31, 2014.

(51) Int. Cl. G06F 17/30

(52) U.S. Cl. CPC G06F 17/30864; G06F 17/3053

(57) ABSTRACT

Methods, systems, and apparatus, including computer programs encoded on a computer storage medium, re-ranking resources for categorical queries. In one aspect, a method includes receiving queries, and for each received query: receiving data indicating resources identified by a search operation as being responsive to the query and ranked according to a first order, each resource having corresponding search score by which the resources are ranked in responsiveness to the query and determining whether a proper subset meets a quality condition based on a quality measure that is indicative of the quality of the resources in the proper subset and independent of search scores of the resources for received query. For each query for which the proper subset meets the quality condition, determining a quality score for each resource in the proper subset and re-ranking the resources in the proper subset according to their respective quality scores.

### CROSS-REFERENCE TO RELATED APPLICATIONS

This application claims the benefit of U.S. Provisional Patent Application Ser. No. 61/972,821, filed on Mar. 31, 2014, the entire disclosure of which is incorporated herein by reference.

### BACKGROUND

The Internet enables access to a wide variety of resources, such as video or audio files, web pages for particular subjects, book articles, or news articles. A search system can identify resources in response to a user query that includes one or more search terms or phrases. The search system ranks the resources based on their relevance to the query and importance and provides search results that link to the identified resources, and orders the search results according to the rank.

Sometimes users are searching general information, while other times users may desire a particular resource. In the case of searching for general information, users will often submit “informational” queries; in the case of search for a particular resource, a user may provide a “navigational” query. An informational query is a query for which there are many relevant results and no one particular result receives the vast majority of selections. An example of informational queries are [football], [space travel], etc. A navigational query, on the other hand, is a query for which there is typically a single website or resource for which corresponding search results receives the vast majority of selections. The single website or resource is generally referred to as a navigational resource for the navigational query. Examples of navigational queries are [youtube], [google], etc.

Sometimes, however, users may have a particular interest in a category of information for which there are a number of well-served resources.

### SUMMARY

This specification describes technologies relating to re-ranking resources based on the quality of the resources.

In general, one innovative aspect of the subject matter described in this specification can be embodied in methods that include the actions of receiving queries, each receive query received from a corresponding user device, and for each received query: receiving data indicating resources identified by a search operation as being responsive to the query and ranked according to a first order, each resource having corresponding search score by which the resources are ranked in responsiveness to the query relative to the other resources identified by a search operation as being responsive to the query, selecting a proper subset of the resources, and determining whether the proper subset meets a quality condition based on a quality measure that is indicative of the quality of the resources in the proper subset and independent of search scores of the resources for received query; for only each query for which the proper subset meets the quality condition: determining a quality score for each resource in the proper subset, the quality score being different from the search score for the resource, and re-ranking the resources in the proper subset according to their respective quality scores. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. By re-ranking search results for a proper subset of resources that satisfy a quality condition, the search system provides a set of search results that lists resources that belong to a category according to a quality ranking that differs from a search ranking of a received query. Because the search results are provided according to a ranking that is based, in part, on quality with respect to the category, the search results are more likely to satisfy a user's informational need when the users issues a query that is categorical for the category. This also obviates the need for the user to issue several separate navigational queries or several informational queries, as the most popular resources with respect to the category tend to be boosted in the ranking during the re-ranking process. Furthermore, the re-ranking can be triggered only for certain queries for which there is a signal of a categorical interest, and not triggered when the query signals a non-categorical interest, such as a navigational interest, or where the query is an answer seeking query, etc. In these latter cases, there is a strong signal of the user's informational need, and thus the re-ranking would likely be of little informational utility to the user.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which resources may be re-ranked based on categorical quality.

FIG. 2 is a flow diagram of an example process for re-ranking resources based on categorical quality.

FIG. 3 is a flow diagram of an example process for determining whether a set of resources meets a quality condition for a category.

FIG. 4 is a flow diagram of an example process for re-ranking resources based on quality scores.

FIG. 5 is a flow diagram of another example process for re-ranking resources based on quality scores.

Like reference numbers and designations in the various drawings indicate like elements.

### DETAILED DESCRIPTION

Overview

As users learn more about a particular topic or category of information, they become less likely to enter broad informational queries for that category. For example, if a user desires to watch online videos, the user is more likely to enter a query such as [youtube] than a broader query such as [online videos]. However, when a user knows very little about the category, the queries are more likely to be broader queries. This is because a user may not have developed an understanding of the category, and may not be aware of the websites and resources that best serve the category.

The systems and methods described below re-rank resources for a broad categorical query by their corresponding quality in the category to which the categorical query corresponds. The set of re-ranked search results are more likely to show the websites and resources that best serve the category.

In one example implementation, the system receives a query and data indicating resources identified by a search operation as being responsive to the query. The resources are ranked according to a first order of responsiveness to the received query. The system then optionally selects a proper subset of the resources, and determines whether the proper subset meets a quality condition based on a quality measure that is indicative of the quality of the resources in the proper subset and independent of search scores of the resources for received query. A variety of quality conditions can be considered, including traffic to each resource, whether each resource is a navigational resource for a corresponding navigational query, the authority of each resource relative to other resources, etc. In some implementations, the quality condition for the subset, for example, may be met when a threshold number of the resources in the proper subset meet a popularity condition. For example, the threshold number may be 70% of the number of resources in the proper subset. The popularity condition may be based on one or more criteria.

A resource satisfying the quality condition is a signal that the resource is a high quality resource for the category to which the received query belongs. Various criteria can be used to determine if a resource satisfies a quality condition, and are described in more detail below.

If the quality condition for the proper subset is met, then the system determines a quality score for each resource. The quality score is a measure of quality of the resource for the category to which the received query belongs. As with the quality condition, various criteria can be used to determine the quality score for a resource, and are described in more detail below.

The system then re-ranks the resources in the proper subset according to their respective quality scores. Thereafter, search results identifying the proper subset of resources based on the re-ranked order and search results based on the original order and identifying the remaining resources may be provided to a user device that issued the query.

These features and other features are described in more detail below.

Example Operating Environment

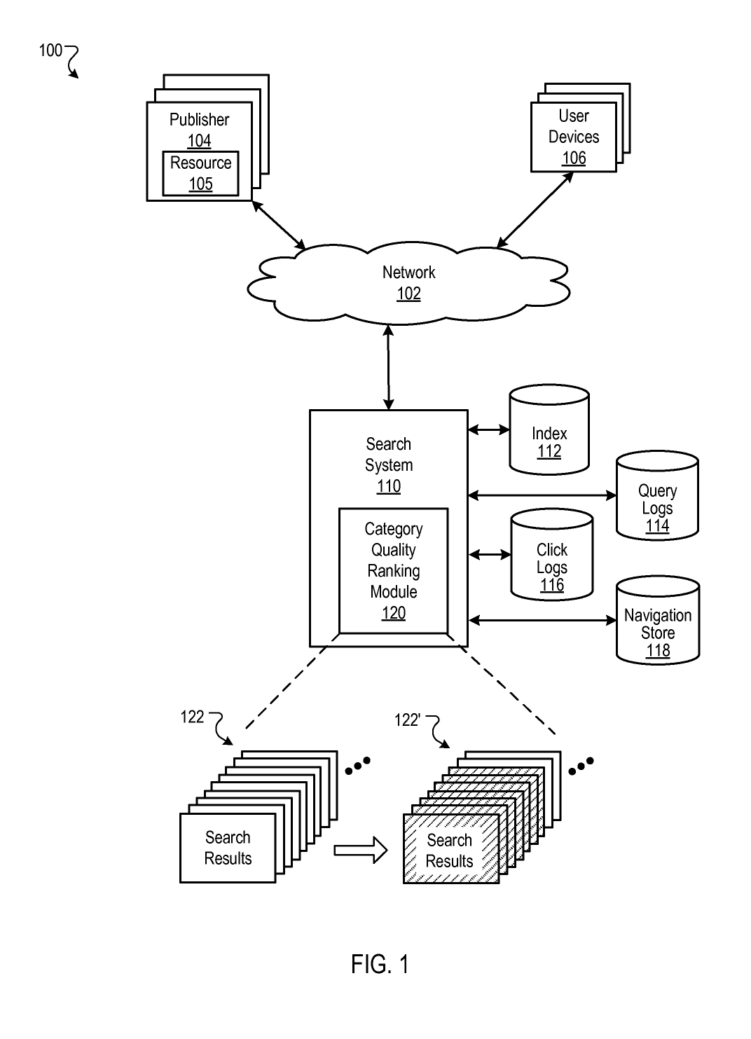

FIG. 1 is a block diagram of an example environment 100 in in which resources may be re-ranked based on categorical quality. A computer network 102, such as the Internet, connects publisher web sites 104, user devices 106, and a search system 110. The online environment 100 may include many thousands of publisher web sites 104 and user devices 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a content publisher, which is an entity that controls, manages and/or owns the website 104.

A resource is any data that can be provided by the publisher 104 over the network 102 and that is associated with a resource address. Resources include HTML pages, images, video, and feed sources, to name just a few. The resources can include content, such as words, phrases, pictures, and so on, and may include embedded information (such as meta information and hyperlinks) and/or embedded instructions (such as scripts).

A user device 106 is an electronic device that is under the control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102. The web browser can enable a user to display and interact with text, images, videos, music and other information typically located on a web page at a website on the world wide web or a local area network.

To facilitate searching of these resources 105, the search system 110 identifies the resources by crawling the publisher web sites 104 and indexing the resources provided by the publisher web sites 104. The indexed data are stored in an index 112.

The user devices 106 submit search queries to the search system 110. In response to the queries, the search system 110 uses the index 112 to identify resources that are relevant to the queries. The search system 110 identifies the resources in the form of search results and returns the search results to the user devices 106 in search results page resource. A search result is data generated by the search system 110 that identifies a resource that satisfies a particular search query, and includes a resource locator, or some other identifier, for the resource. An example search result can include a web page title, a snippet of text extracted from the web page, and the URL of the web page.

The search results are ranked based on search scores for the resources identified by the search results. The search operation quantifies the relevance of the resources to the query, and can be based on a variety of factors. Such factors include information retrieval (“IR”) scores, user feedback scores, and optionally a separate ranking of each resource relative to other resources (e.g., an authority score). The search results are ordered according to these search scores and provided to the user device according to the order.

The user devices 106 receive the search results pages and render the pages for presentation to users. In response to the user selecting a search result at a user device 106, the user device 106 requests the resource identified by the resource locator included in the selected search result. The publisher of the web site 104 hosting the resource receives the request for the resource from the user device 106 and provides the resource to the requesting user device 106.

In some implementations, the queries submitted from user devices 106 are stored in query logs 114. Click data for the queries and the web pages referenced by the search results are stored in click logs 116. The query logs 114 and the click logs 116 define search history data that include data from and related to previous search requests. The query logs 114 and click logs 116 can be used to map queries submitted by the user devices to web pages that were identified in search results and the actions taken by users. The click logs 116 and query logs 114 can thus be used by the search system to determine queries submitted by the user devices, the actions taken in response to the queries, and how often the queries are submitted.

In some implementations, the search system 110 processes the click logs and the query logs to determine navigational scores for the queries. A navigational score for a query is a measure of the query being a navigational query for a resource, and a query may have many navigational scores, each corresponding to a resource or website. The navigational score may be a binary score. For this scoring scheme, a score corresponding to a resource or website for which the query is navigational is set to 1. For all other resources and websites, the score is set to 0. This type of scoring model is based on the premise that a query is only navigational for one resource, or for one website.

Alternatively, the navigational score may be a score within an upper bound and a lower bound, and a query has a separate navigational score for each of multiple resources. In these implementations, an informational query may have a relatively flat score for many resources, indicating such resources are selected often for the query when identified by search results, and the score may gradually decrease to the lower bound for the remaining resources that are rarely selected for the query. Conversely, a navigational query may have a very high navigational score for one resource (or several resources belonging to a one website), and a very low score for all other resources. This latter scoring distribution is indicative of the query being used to find the one resource or website almost exclusively; in other words, the user “navigates” to the one resource or website by use of the query.

The navigational scores for the queries and corresponding resources are stored in a navigation store 118 and may be accessed at query time to identify navigational scores of queries for resources, and to further identify navigational queries for a resource. For example, for a particular resource, each query having a navigational score that meets a navigational threshold may be considered to be a navigational query for that resource. In general, a resource or website may have multiple navigational queries, but a navigational query is navigational for only one resource of website.

The search system 110 also includes a category quality ranking module 220 that re-ranks resources based on their quality to a category to which a query belongs. As described above, if the quality condition is met, e.g., if a threshold number of resources identified for a query subset meet a quality condition, then the resources may be re-ranked according to quality scores for a category to which the query corresponds. While all scored resources may be processed when determining whether a quality condition is met, in some implementations only a proper subset of the top N ranked resources for a search operational are processed.

Because a resource satisfying the quality condition is a signal that the resource is a popular resource for the category to which the received query belongs, the threshold number of the resources in the proper subset meeting the quality condition is indicative that the proper subset is, in the aggregate, a collection of resources that are very likely to satisfy a user's informational need with respect to that category. Thus, the proper subset is re-ranked based on the quality of the resources for the category to which the received query belongs. Thereafter, search results identifying the resources based on the re-ranked order and the original order of the remaining resources may be provided to a user device that issued the query. For example, as shown in FIG. 1, the set of search results 122 are re-ordered to form the second set 122′. A shaded proper subset indicates the search results that are re-ordered based on the re-ranking of the underlying resources the search results identify.

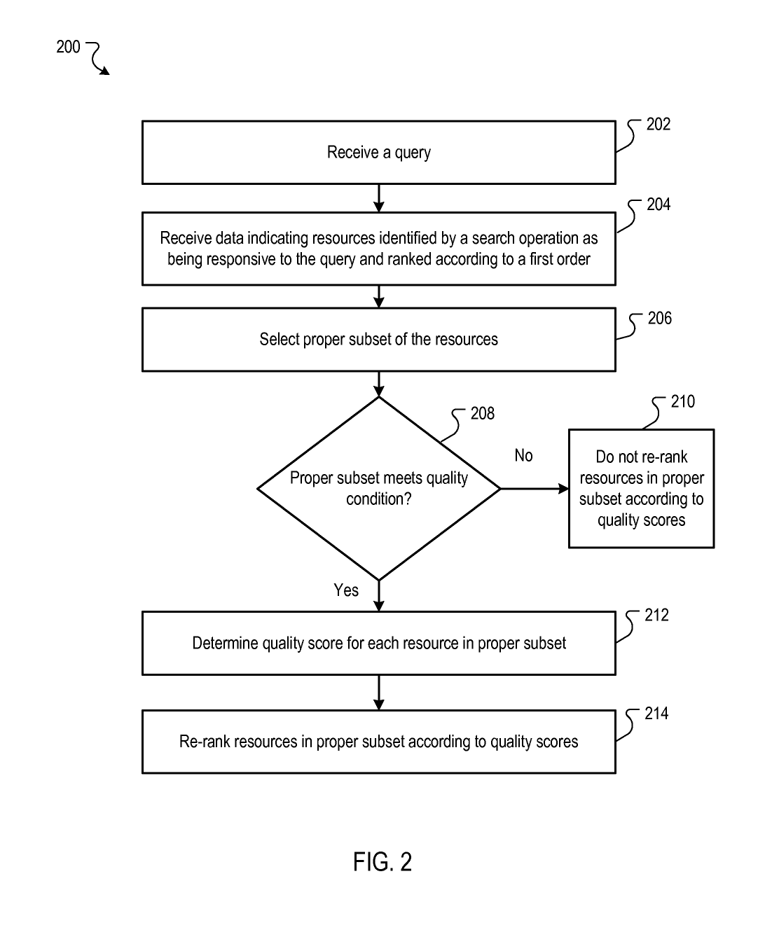

The processes for determining when to re-rank resources and how the resources are re-ranked are described with reference to FIGS. 2-5 below.

Re-Ranking Resources for Categorical Queries

FIG. 2 is a flow diagram of an example process 200 for re-ranking resources based on categorical quality. The process 200 can be used in the category quality ranking module 120. In some implementations, that process 200 is done for each query received; however, in FIG. 2, the process 200 is described in the context of a single query.

The process 200 receives a query (202). For example, the category quality ranking module 120 receives, from the search system 110, a query submitted by a user device 106. The query has one or more terms.

The process 200 receives data indicating resources identified by a search operation as being responsive to the query and ranked according to a first order (204). For example, the category quality ranking module 120 receives data describing the output of a search of the index 112 using the query. Typically a set of resources are identified, and each identified resource has a corresponding search score. The resources are ranked in responsiveness to the query relative to the other resources identified by a search operation as being responsive to the query. All indexed resources 112 are usually not scored; for example, the data may describe the top 1,000 scored resources.

The checking of whether the resources meet a quality condition can be done on the entire set of resources identified by the data. However, as many of these resources are likely to be only marginally relevant, especially those resources ranked near the bottom of the set, it is more efficient to select a set of the top ranked resources. Thus, in some implementations, the process 200 selects a proper subset of the resources (206). For example, the category quality ranking module 120 may select N resources ranked in the top N positions in the first order. Any appropriate value of N may be used. The value may be, for example, 10, or may be some other relatively small value, 20 or 30.

In some implementations, the value of N is the same for each category type to which the query belongs. In other implementations, the value of N may be category dependent. In the latter implementations, the search system 110 can categorize the query and provide to the category quality ranking module 120 data describing the categorization of the query. A variety of categorization techniques can be used to categorize a query, examples of which include query clustering, vertical categorization based on selections of search results responsive to the query, and so on.

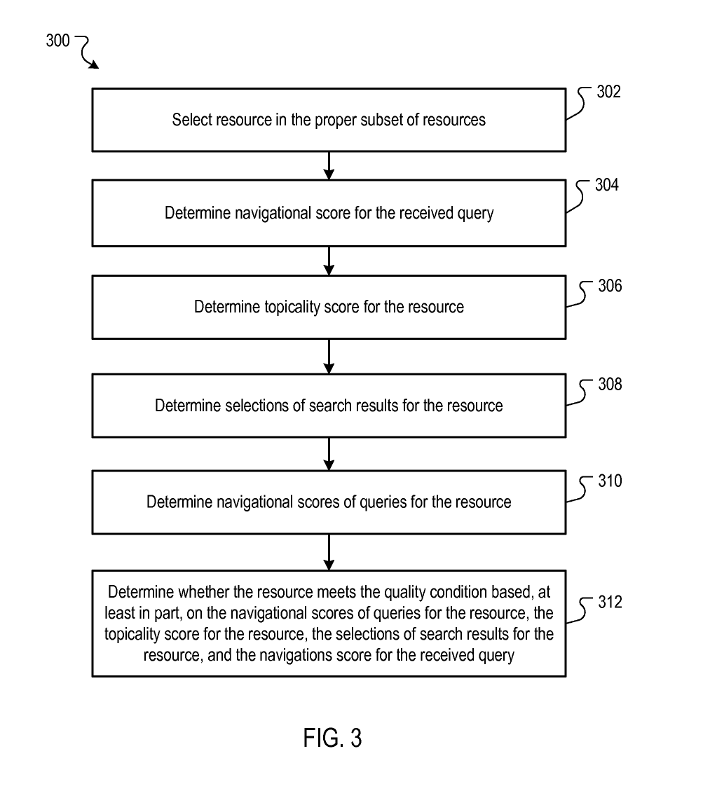

The process 200 determines whether the proper subset meets a quality condition (208). For example, in one implementation, the process determines whether a threshold number of resources in the proper subset meet a quality condition. For example, for each resource in the proper subset, the category quality ranking module 120 may perform the process 300 described with reference to FIG. 3 below to determine if the resource meets a quality condition. The number of resources that meet the quality condition is compared to the threshold number. The threshold number can be a percentage of N, e.g., 50%, 60%, or some other value.

If the proper subset does not meet the quality condition, e.g., if a threshold number of resources in the proper subset does not meet the quality condition, then the process 200 does not re-rank resources in proper subset according to quality scores (210). For example, the category quality ranking module 120 does not perform a subsequent scoring on the resources, and the search system 110 may then return search results to the user device 106 according to the first order, or may perform other post search operation processes before returning search results to the user device 106.

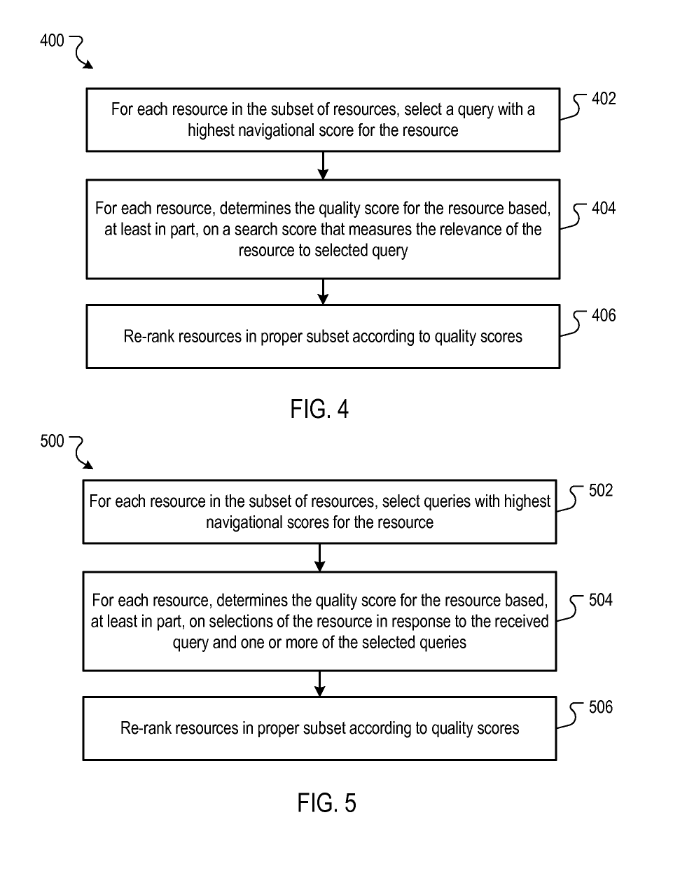

Conversely, if the proper subset does meet the quality condition, e.g., if the threshold number of resources in the proper subset meets the quality condition, then the process 200 determines a quality score for each resource in the subset (212). For example, the category quality ranking module 120 may perform the processes 400 or 500 described with reference to FIGS. 4 and 5 below to determine a quality score for each resource. Other processes may also be used instead of those described with reference to FIGS. 4 and 5 below.

The process 200 then re-ranks resources in the proper subset according to quality scores (214). For example, the category quality ranking module 120 may adjust each search score of a resources based on the quality score, e.g., by multiplying the search score by the quality score, or based on some other linear combination of the search score and quality score. Alternatively, the resources in the proper subset can be re-ranked solely on their corresponding quality scores and without regarding to the original search scores.

After re-ranking, the search results identifying the proper subset of resources may be provided to the user device 106 according to the re-ranked order.

Quality Condition for a Resource Set

A variety of features may be considered to determine whether a resource set meets a quality condition. The quality of each resource, and thus the quality of a set of resources, can be measured independent of search scores of the resources for received query. For example, the quality of each resource can be based on one or more of the authority of the resource relative to other resources, the traffic for each resource, the relevance of the resource to other queries that are different from the received query, or other factors that can be used to determine a quality measure of the set of resources. More generally, the quality measure is based on one or more signals that may be indicative of the ability of the resources that belong to the set to satisfy a user's informational need for a category to which a received query belongs.

FIG. 3 is a flow diagram of an example process 300 for determining whether a set of resources meets a quality condition for a category. The process 300 can be used in the category quality ranking module 120. In the example process 300, four features are determined for each resource—the quality of the resource as measured by navigational queries (if any); the topicality of the resource to the received query; the performance of search results that reference the resource; and whether the received query is itself a navigational query. The process 300 is performed on each resource in the proper subset.

In some implementations, each of these features may be measured by a corresponding value, and the values may be provided as input to a linear function that produces an output that is compared to a threshold. If the threshold is met, then the resource is determined to meet the quality condition for the category. Alternatively, each of these features may be measured by a corresponding value that is compared to a correspond threshold, and if all (or a majority) of thresholds are met, then the resource is determined to meet the quality condition for the category. Additional features, or fewer features, can also be considered when determining whether a resource meets a quality condition.

The process 300 selects a resource in the proper subset of resources (302). For example, the category quality ranking module 120 selects one of the resources in the the top N ranked resources.

The process 300 determines a navigational score for the received query (304). For example, the category quality ranking module 120 accesses the navigation store 118 to determine whether the received query is classified as a navigational query for any resource, or otherwise accesses the navigational scores for the query with respect to any resource. A received query being classified as a navigational query for a resource, or otherwise having a very high navigational score for a resource relative to other queries, is indicative of a user searching for the particular resource when the user issues the query. For example, the query [youtube], which has a very high navigational score for the website Youtube, is often provided by users that want to navigate to the Youtube website. Accordingly, when such a query is received, a user is less likely to be interested in other resources than when the user enters a more general, informational query such as [online videos].

As described above, a navigational interest is a strong signal of the user's informational need, and thus the re-ranking would likely be of little informational utility to the user. Thus, when a received query is a navigational query, or has a very high navigational score for a resource, the category quality ranking module 120 is configured to be less likely to determine that a resource in the proper subset meets the quality condition. This, in turn, makes it less likely that the proper subset of resources meets the quality condition, and thus re-ranking of the proper subset of resources is also less likely.

The process 300 determines a topicality score for the resource (306). For example, the category quality ranking module 120 determines a score that measures how topical the resource is for the query. A variety of topicality scoring processes can be used. For example, the similarity of query terms to terms in the resources can be determined, and the more similar the terms of the query to the terms of the resource, the higher the topicality score. By way of another example, the performance of search results that reference the resource when provided in response to the query can be determined. The higher the performance (e.g., selection rate), the higher the topicality score. Other topicality scoring processes can also be used. The higher the topicality score, the more likely the resource is to meet the quality condition.

The process 300 determines selections of search results for the resource (308). For example, the category quality ranking module 120 determines a score based on an aggregation of selections of search results for the resource for all queries. Generally the better the overall performance of a resource, the more likely the resource is to meet the quality condition.

The process 300 determines navigational scores of queries for the resource (310). For example, the category quality ranking module 120 accesses the navigation store 118 to determine whether the resource has any corresponding navigational queries, or otherwise determine the navigational scores for the queries. The existence of one or more navigational queries for a resource, or a set of queries with relatively high navigational scores, is indicative of the resource being a popular resource. The determination is based on queries that are different from the received query, as a high navigational score of the received query may preclude or otherwise reduce the likelihood of re-ranking the proper subset of the resources.

For example, assume the received query is [online videos]. While search results for the website Youtube may perform well for this query, they may nevertheless perform much better for navigational queries such as [youtube], [youtube videos], etc. Likewise, other websites and resources may also perform well for other navigational queries.

Conversely, assume one of the resources in the proper subset contains an article describing how to post on-line videos in a blog. While search results for the resource may perform relatively well for several queries, there may be no query that exhibits navigational behavior for the resource. Thus, this resource would be less likely to meet the quality condition than would a resource from the Youtube website.

In some implementations, the navigational scores of the queries is used to determine a navigational score value for the resource. As described above, some queries may have a binary classification as being navigational for a resource. In these implementations, the number of navigational queries, or their corresponding click counts, maybe counted to determine the value. However, in some implementations in which queries are not classified as navigational, the navigational scores of queries may be evaluated. Resources that have a small set of queries with relatively high navigational scores are determined to be more popular than resources for which queries have a respectively flatter distribution of navigational scores. The resulting value may be determined based on, for example, the top M highest navigational scores for queries for the resource, or by some other appropriate relationship.

The process 300 determines whether the resource meets the quality condition based, at least in part, on the navigational scores of queries for the resource, the topicality score for the resource, the selections of search results for the resource, and the navigational score for the received query (312). For example, the category quality ranking module 120 may apply a threshold to each navigational score of the queries for the resource, the topicality score for the resource, the selections of search results for the resource, and the navigational score for the received query. Each threshold must be met, or, alternatively, a majority of thresholds must be met, for the resource to meet the quality condition.

Alternatively, the category quality ranking module 120 may input each value into a formula, such as:

Q_Cond_Val(Rᵢ, RQ)=f(NS_Qᵢ, TSi, SRS_Rᵢ, NS_RQ)

where:

Rᵢ is the i^{th} resource in the proper subset of resources;

RQ is the received query;

NS_Qᵢ is a value based on the navigational scores of queries for Rᵢ;

TSᵢ=is topicality score based on Rᵢ and RQ;

SRS_Rᵢ=is a value based on the overall performance of search results for Rᵢ;

NS_RQ=is a navigational score for RQ; and

Q_Cond_Val(Rᵢ, RQ) is a value output by the formula f( ).

The value Q_Cond_Val(Rᵢ, RQ) can be compared to a threshold to determine if the resource Rᵢ meets the quality condition.

In some implementations, if a threshold number of resources in the proper subset meet the quality condition, then the set is determined to meet the quality condition. However, in other implementations, the constituent scores of Q_Cond_Val(Rᵢ, RQ) can be combined by a liner function to determine if the proper subset meets the quality condition.

As noted above, additional or fewer metrics can be used to determine if the proper subset meets the quality condition. For example, aggregate visits to a resource, social network shares for a resource, and traffic patterns can also be used.

Quality Scores for Resources

If the proper subset of resources is determined to meet the quality condition, e.g., if a threshold number of resources in the proper subset meet the quality condition, or if the combined scores of Q_Cond_Val(Rᵢ, RQ) meet the popularity condition, then the proper subset meets the quality condition. When this occurs, quality scores for the resources are determined and the resources are re-ranked based on the quality scores.

Quality scores for resources can, in some implementations, be the values determine for the quality condition described above, e.g., Q_Cond_Val(Rᵢ, RQ). However, in other implementations, other factors can be used to determine the quality scores for resources. Two such examples are described with reference to FIGS. 4 and 5 below.

FIG. 4 is a flow diagram of an example process 400 for re-ranking resources based on quality scores. The process 400 can be used in the category quality ranking module 120.

The process 400, for each resource in the subset of resources, selects a query with a highest navigational score for the resource (402). For example, assume the received query is [online videos] and the query with the highest navigational score for the resource at www.youtube.com is [Youtube]. The query [youtube] is thus selected by the category quality ranking module 120.

The process 400, for each resource in the subset of resources, determines the quality score for the resource based, at least in part, on a search score that measures the relevance of the resource to the selected query (404). For example, the category quality ranking module 120 invokes the search system 110 to determine a search score for the resource at www.youtube.com based on the query [Youtube]. This new search score is used for the quality score.

The process 400 re-rank resources in proper subset according to quality scores (406). For example, the category quality ranking module 120 ranks the resource at www.youtube.com based on the search score determined for the query [Youtube], instead of the search score initially determined for the query [online videos]. Likewise, each other resource is re-ranked based on a search score determined for a respective query with a highest navigational score for that resource.

FIG. 5 is a flow diagram of another example process 500 for re-ranking resources based on quality scores. The process 500 can be used in the category quality ranking module 120. For example, the category quality ranking module 120.

The process 500, for each resource in the subset of resources, selects queries with highest navigational scores for the resource (502). For example, the category quality ranking module 120 may select the top M queries for a resource based on the highest navigational scores, or may select each query having a navigational score that meets or exceeds a navigational score threshold.

The process 500, for each resource in the subset of resources, determines the quality score for the resource based, at least in part, on selections of the resource in response to the received query and one or more of the selected navigational queries (504). For example, the category quality ranking module 120, for a first resource, may select two queries based on navigational scores. Each of the three queries and the received query may have corresponding selection counts for search results that reference the first resource, e.g., the resource may have been selected J times for queries that match the received query; K times for queries that match the first selected query; and L times for queries that match the second selected query, where L>K, and K>J. The quality score may be based on the summation of J, K and L.

Alternatively, the quality score may be based only on the summation K and L, and selections for received query are ignored.

The process then 500 re-ranks resources in proper subset according to quality scores (506).

Other factors can be considered when determining quality scores. For example, for each resource, the category quality ranking module 120 can determine a quality score for the resource that is measure of quality of the resource relative to other resources and independent of any query. The quality score can be based the authority of the resource relative to other resources, features of the resource itself, etc.

Additional Implementation Details

In some implementations, the re-ranking of resources may be disabled for certain queries. For example, for queries that have a high locality intent, the re-ranking may be disabled as the locality intent is a signal that user has a specific informational need that should not be discounted. An example of a query with a high locality intent is [Videos in Mountain View, Calif.].

In some implementations, only resources in the proper subset that are determined to meet the quality condition are re-ranked; the other resources that do not can be held at their original ordinal positions. In a variation of this implementation, only resources in the proper subset that are determined to meet the quality condition are re-scored based on quality scores, while the other resources that do not meet the popularity condition are not re-scored. All the resources in the proper subset are then re-ranked based on their corresponding scores.

In some implementations, only resources in the proper subset that are determined to meet the quality condition are re-ranked; the other resources that do are demoted to occupy the least significant ordinal positions in the proper subset. For example, assume the proper subset is 10 resources, and the resources at the third and fourth ordinal positions do not meet the quality condition. After re-ranking, these two resources will occupy positions 9 and 10, respectively.

In some implementations, resources may be re-ranked based on results for the domains to which the resources belong. For example, the most relevant results for the query [dining tables] may be resources that belong to the domains of popular furniture retailers. While the homepage of each retailer may have, for example, very high quality scores based on one or more of traffic, navigational queries, authority, or other appropriate signals being used to determine quality of a resource, the actual resource referenced by a search result that is a sub-page belonging to the domain may not have such high quality scores.

Thus, in some implementations, a secondary (or alternative) quality determination may be made for each resource based on the domain to which the resource belongs. For example, the domain of each resource may be determined, and determining whether the proper subset of resources meets the quality condition can be based on domain level data. The domain level data may be, for example, data for the host or “home page” of the domain, or aggregate data derived from corresponding data for resources that belong to the domain. If the proper subset of resources meets the quality condition based on domain level data, then domain-level data can also be used to determine quality scores that are attributed to each resource, and these domain-level quality scores are used to re-rank the resources.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving queries, each query received from a corresponding user device;
for each query received:
receiving data indicating resources identified by a search operation as being responsive to the query and ranked according to a first order, each resource having corresponding search score by which the resources are ranked in responsiveness to the query relative to the other resources identified by a search operation as being responsive to the query;
selecting a proper subset of the resources, the proper subset of resources including at least two or more resources;
for each resource in the proper subset, determining a constituent score for the resource, the constituent score being indicative of whether the resource meets a quality condition; and
determining whether the proper subset meets the quality condition based on a quality measure for the proper subset that is indicative of the quality of the resources in the proper subset and independent of search scores of the resources for the query, wherein the quality measure for the proper subset is based in part on the respective constituent score for each resource in the proper subset and applies to the proper subset;
for only each query for which the proper subset meets the quality condition:
determining a quality score for each resource in the proper subset, the quality score being different from the search score for the resource, the determining the quality score comprising:
selecting a query as a selected query for the resource, the selected query being a query that has a highest navigational score for the resource relative to navigational scores for other queries for the resources, wherein the selected query is different from one or more selected queries for other resources in the proper subset, and the selected query is different from the query received, and the query received is not a navigational query for the resource; and
determining the quality score for the resource based, at least in part, on a search score that measures the relevance of the resource to the selected query having the highest navigational score for the resource; and
re-ranking the resources in the proper subset according to their respective quality scores.

2. The method of claim 1, wherein selecting the proper subset of the resources comprises selecting N resources ranked in the top N positions in the first order.

3. The method of claim 1, wherein determining whether the proper subset meets a quality condition comprises determining whether a threshold number of the resources in the proper subset meets the quality condition.

4. The method of claim 3, wherein determining whether the threshold number of the resources in the proper subset meets the quality condition comprises, for each resource in the proper subset:
determining navigational scores of queries for the resource, each navigational score of a query for resource being a measure of the query being a navigational query for a resource, and wherein each of the queries is different from the query received;
determining a topicality score for the resource, the topicality score being a measure of topical relatedness of the resource to the query; and
determining whether the resource meets the quality condition based, at least in part, on the navigational scores of the queries for the resource and the topicality score for the resource.

5. The method of claim 4, wherein determining whether the threshold number of the resources in the proper subset meets the quality condition comprises, for each resource in the proper subset:
determining a first number of selections of search results that identify the resource; and
determining whether the resource meets the quality condition based, at least in part, on the navigational scores of the queries for the resource, the topicality score for the resource, and the first number of selections for the resource.

6. The method of claim 5, wherein determining whether the threshold number of the resources in the proper subset meets the quality condition comprises, for each resource in the proper subset:
determining a navigational score for the query, the navigational score for the query being a measure of the query being a navigational query for a resource; and
determining whether the resource meets the quality condition based, at least in part, on the navigational scores of the queries for the resource, the topicality score for the resource, the first number of selections for the resource, and the navigational score for the query.

7. (canceled)

8. The method of claim 1, wherein determining a quality score for each resource in the proper subset comprises, for each resource:
selecting a query for the resource that has a highest navigational score for the resource relative to navigational scores for other queries for the resources; and
determining the quality score for the resource based, at least in part, on a first number of selections of search results that reference the resource and provided in response to the selected query having the highest navigational score for the resource and a second number of selections of search results that reference the resource and provided in response to the query.

9. The method of claim 1, wherein determining a quality score for each resource in the proper subset comprises, for each resource:
determining a first number of selections of search results that identify the resource; and
determining the quality score for the resource based, at least in part, on the first number of selections for the resources.

10. The method of claim 1, wherein determining a quality score for each resource in the proper subset comprises, for each resource:
determining a quality score for the resource that is a measure of quality of the resource relative to other resources and independent of a query.

11. The method of claim 1, wherein determining a quality score for each resource in the proper subset comprises, for each resource:
determining a domain to which the resource belongs; and
determining the quality score for the resource based on domain-level data.

12. The method of claim 11, wherein the domain-level data are aggregate data derived from the resource in the proper subset and other resources that are not in the proper sub set.

13. A computer storage medium encoded with a computer program, the program comprising instructions that when executed by data processing apparatus cause the data processing apparatus to perform operations comprising:
receiving queries, each received query received from a corresponding user device;
for each query received:
receiving data indicating resources identified by a search operation as being responsive to the query and ranked according to a first order, each resource having corresponding search score by which the resources are ranked in responsiveness to the query relative to the other resources identified by a search operation as being responsive to the query;
selecting a proper subset of the resources, the proper subset of resources including at least two or more resources; and
for each resource in the proper subset, determining a constituent score for the resource, the constituent score being indicative of whether the resource meets a quality condition; and
determining whether the proper subset meets the quality condition based on a quality measure for the proper subset that is indicative of the quality of the resources in the proper subset and independent of search scores of the resources for the query, wherein the quality measure for the proper subset is based in part on the respective constituent score for each resource in the proper subset and applies to the proper subset; and
for only each query for which the proper subset meets the quality condition:
determining a quality score for each resource in the proper subset, the quality score being different from the search score for the resource, the determining the quality score comprising:
selecting a query as a selected query for the resource, the selected query being a query that has a highest navigational score for the resource relative to navigational scores for other queries for the resources, wherein the selected query is different from one or more selected queries for other resources in the proper subset, and the selected query is different from the query received, and the query received is not a navigational query for the resource; and
determining the quality score for the resource based, at least in part, on a search score that measures the relevance of the resource to the selected query having the highest navigational score for the resource; and
re-ranking the resources in the proper subset according to their respective quality scores.

14. The computer storage medium of claim 13, wherein determining whether the proper subset meets a quality condition comprises determining whether a threshold number of the resources in the proper subset meets the quality condition.

15. The computer storage medium of claim 14, wherein determining whether the threshold number of the resources in the proper subset meets the quality condition comprises, for each resource in the proper subset:
determining navigational scores of queries for the resource, each navigational score of a query for resource being a measure of the query being a navigational query for a resource, and wherein each of the queries is different from the query received;
determining a topicality score for the resource, the topicality score being a measure of topical relatedness of the resource to the query; and
determining whether the resource meets the quality condition based, at least in part, on the navigational scores of the queries for the resource and the topicality score for the resource.

16. A system, comprising:
a data processing apparatus; and
software stored in non-transitory computer readable storage medium storing instructions executable by the data processing apparatus and that upon such execution cause the data processing apparatus to perform operations comprising:
receiving queries, each received query received from a corresponding user device;
for each query received:
receiving data indicating resources identified by a search operation as being responsive to the query and ranked according to a first order, each resource having corresponding search score by which the resources are ranked in responsiveness to the query relative to the other resources identified by a search operation as being responsive to the query;
selecting a proper subset of the resources, the proper subset of resources including at least two or more resources; and
for each resource in the proper subset, determining a constituent score for the resource, the constituent score being indicative of whether the resource meets a quality condition; and
determining whether the proper subset meets the quality condition based on a quality measure for the proper subset that is indicative of the quality of the resources in the proper subset and independent of search scores of the resources for the query, wherein the quality measure for the proper subset is based in part on the respective constituent score for each resource in the proper subset and applies to the proper subset;
for only each query for which the proper subset meets the quality condition:
determining a quality score for each resource in the proper subset, the quality score being different from the search score for the resource, the determining the quality score comprising:
selecting a query as a selected query for the resource, the selected query being a query that has a highest navigational score for the resource relative to navigational scores for other queries for the resources, wherein the selected query is different from one or more selected queries for other resources in the proper subset, and the selected query is different from the query received, and the query received is not a navigational query for the resource; and
determining the quality score for the resource based, at least in part, on a search score that measures the relevance of the resource to the selected query having the highest navigational score for the resource; and
re-ranking the resources in the proper subset according to their respective quality scores.

17. The system of claim 16, wherein determining whether the proper subset meets a quality condition comprises determining whether a threshold number of the resources in the proper subset meets the quality condition.

18. The system of claim 17, wherein determining whether the threshold number of the resources in the proper subset meets the quality condition comprises, for each resource in the proper subset:
determining navigational scores of queries for the resource, each navigational score of a query for resource being a measure of the query being a navigational query for a resource, and wherein each of the queries is different from the query received;
determining a topicality score for the resource, the topicality score being a measure of topical relatedness of the resource to the query; and
determining whether the resource meets the quality condition based, at least in part, on the navigational scores of the queries for the resource and the topicality score for the resource.

19. (canceled)

20. The system of claim 16, wherein determining a quality score for each resource in the proper subset comprises, for each resource:
selecting a query for the resource that has a highest navigational score for the resource relative to navigational scores for other queries for the resources; and
determining the quality score for the resource based, at least in part, on a first number of selections of search results that reference the resource and provided in response to the selected query having the highest navigational score for the resource and a second number of selections of search results that reference the resource and provided in response to the query.
